(19) United States
(12) Patent Application Publication
(10) Pub. No.: US 2023/0021281 A1
(43) Pub. Date: Jan. 19, 2023

(54) METHOD AND APPARATUS FOR MELTING AND REFINING GLASS, GLASS CERAMIC, AND GLASS CERAMIFIABLE TO GLASS CERAMIC

(71) Applicant: SCHOTT AG, Mainz (DE)

(72) Inventors: Hildegard RÖMER, Karben (DE); Wolfgang SCHMIDBAUER, Mainz (DE); Michael HAHN, Hohenstein (DE); Stefan SCHMITT, Stadecken-Elsheim (DE); Klaus SCHÖNBERGER, Mainz (DE)

(73) Assignee: SCHOTT AG, Mainz (DE)

(21) Appl. No.: 17/930,005

(22) Filed: Sep. 6, 2022

Related U.S. Application Data
(63) Continuation of application No. PCT/EP2021/055511, filed on Mar. 4, 2021.

(30) Foreign Application Priority Data
Mar. 5, 2020 (DE) 10 2020 106 050.5

(51) Int. Cl. C03B 5/02; C03B 5/225; C03B 5/03

(52) U.S. Cl. CPC C03B 5/021; C03B 5/225; C03B 5/03; C03B 2211/70

(57) ABSTRACT

A method and an apparatus for melting and refining glass, glass ceramic, or ceramizable to form glass ceramic are provided. The method and apparatus refine the materials such that less than 1 bubble/kg is included in the molten and refined material and the direct CO₂ emissions amount to less than 100 kg per ton of molten material during the melting and refining.

### CROSS REFERENCE TO RELATED APPLICATIONS

This application is a continuation of International Application PCT/EP2021/055511 filed Mar. 4, 2021, which claims the benefit under 35 USC § 119 of German Application 10 2020 106 050.5 filed Mar. 5, 2020, the entire contents of all of which are incorporated herein by reference.

### BACKGROUND

### 1. Field of the Invention

The invention relates to a method and to an apparatus for melting and refining glass, glass ceramic, or in particular glass that can be ceramized to form glass ceramic, and to glass or glass ceramic produced according to such method.

### 2. Description of Related Art

Conventional tanks for melting down or melting glass or glass ceramics usually comprise a fossil fuel-heated upper furnace and optionally an electrical auxiliary heater. Depending on specified requirements and melting temperature, such tanks typically require 150-500 cbm of gas and up to 1500 kWh of electrical energy per ton of molten glass to produce special glass, which corresponds to CO₂ emissions of 700 to 1500 kg CO₂ per ton of glass.

If only the CO₂ emissions from the combustion of fossil fuels are taken into account, typical tanks currently require about 300 to 1200 kg CO₂ per ton of glass. A proportion of up to 100 kg CO₂ per ton (t) of glass typically results from the melting reaction of the raw materials used.

All-electric tanks which, for short, will also be referred to as AE tanks below, are tanks that do not involve any fossil fueling and therefore do not produce direct CO₂ emissions. However, a drawback of such tanks is that, hitherto, high quality requirements could not yet been met. The molten glass had more than one bubble per kg of molten glass, usually even more than 10 bubbles per kg of molten glass.

In the context of the present disclosure, direct CO₂ emission refers to those CO₂ emissions that occur in the vicinity of the tank itself, i.e. which are caused by the heating of the tank and the material held therein to be melted, and by the refining of the latter.

CO₂ emissions as produced by the generating of electrical energy are not meant to be direct CO₂ emissions in the context of the present disclosure, but are discussed with regard to the overall CO₂ balance and taken into account accordingly.

However, the enhancement of glass quality is usually limited in AE tanks, especially with regard to the use of refining agents.

In fully electrically operated tanks, redox refining agents can only be used to a limited extent, since they cause electrode corrosion and thus damage the tank, and because redox refining agents require a type of temperature/process control that is not possible in AE tanks. Redox refining agents typically used in the glass industry include arsenic or antimony oxide or tin oxide.

Possible other refining agents such as chloride or sulphate can also be used. For special glass it is important that after the melting, a step is included which increases the temperature by at least 100° C., better 200° C., during which the residual bubble content is reduced by physical or chemical refining. The absence of such a refining phase will lead to a poorer quality of the molten glass or the molten glass ceramic, which up to now has meant that the requirements necessary for special glass could not be met.

In the context of the present disclosure, special glass is understood to mean glass which has special properties which are usually required by the respective field of application, including technical and optical glasses for example.

More particularly, in the context of the present disclosure, only glasses with special quality requirements are referred to as special glasses. These are glasses with less than 10 defects/kg in the refined glass or in the glass ceramic subsequently produced from these glasses. Here, defects are understood to be gaseous inclusions such as bubbles, knots, streaks, or particulate inclusions such as particles introduced from the material of the respective tank, that are found in the subsequent glass after the refining.

An AE tank is described in CN 108585441 A, for example. In this document, the highest temperature occurs in the homogenization area, so there is no refining zone and no refining tank. This document does not aim to achieve high glass qualities.

The document with application number CN 2012 20 676 399 U discloses a heated Mo channel which is connected downstream of an AE tank. This refining device has a height of 100-200 mm and, consequently, what is described is a flat-bed refining process. A drawback of this concept is that, due to the material, maximum achievable refining temperatures are 1600/1700° C., and these temperatures are not sufficient for the bubble-free quality required here. In addition, the refining tank has an unfavorable surface-to-volume ratio, which impairs the efficiency of refining.

DE 43 13 217 C1 also discloses the connection of a refining tank downstream of an AE tank and describes refining by introducing bubbles into the glass to be refined, which is also referred to as bubbling, in a fully electrically heated tank. However, the bubbling usually introduces more foreign gases into the glass to be refined than refining bubbles are removed. Moreover, the temperature in the refining tank disclosed in this document is rather low, so that the refining disclosed there cannot provide the glass quality presently required.

An AE tank for borosilicate glass is described in DD 288368 A. This tank comprises an all-electric melting tank and has a flow passage to a working tank. However, no refining tank is disclosed.

DD 201021 A discloses an AE tank with a deep refining well in which the bubbles are to be “squashed”. However, this procedure does not result in a degassing of the melt. Glass melts of this type are highly susceptible to reboiling and not suitable for producing special glass with high requirements on homogeneity and which are free of bubbles.

Application documents DE 10 2007 008 299 A1 and DE 102 02 024 A1 describe melting units, some of which are fully RF-heated. Both the melting tank and the refining tank are in the form of RF crucibles. However, melting rates of only less than 5 tons per day (t/d) can be achieved in this tank configuration. The same also applies to small platinum tanks such as those used for optical glasses, which enable CO₂-free melting, since burners with fossil gases do not have to be used with these small tanks. These tanks are also limited to a maximum throughput of about 5 t/d.

### SUMMARY

The invention is based on the object of specifying a method and an apparatus which allow for the melting and refining of glass or glass ceramics in a CO₂-free or at least CO₂-reduced manner.

Furthermore, glasses and glass ceramics produced by the method according to the invention are given by way of example.

In particular, it is also intended to provide a melting and refining tank for special glass with high quality requirements, in particular with less than 1 bubble/kg, and with high efficiency, in particular with a melting load, also referred to as surface load, of more than 1 t/m²d.

Usually, the specification of the melting load takes into account the surface area of the melting tank plus the surface area of the refining tank. However, it is not the “free” melting surface that is considered here, but the “working surface area” resulting from the plan view of the aggregates. The melting load thus indicates the amount of melted and refined glass per unit surface area and unit time. Here, the unit time specified is typically the day (d) in this technical field.

This shall be explained by an example as follows. An all-electric tank with a tank size of 4×4 m, i.e. a surface area of the meltdown or melting tank plus the surface area of the refining furnace having an exemplary size of 16 square meters in a top plan view, which produces 32 tons of glass per day, consequently has a melting area of 32 square meters and thus a surface load or melting load of 1 t/m²d.

However, the possible melting load is influenced by the necessary glass quality and the design of the melting and refining tanks, and with the design of the melting units presently disclosed, in particular with the configuration of the refining tank, a glass quality as mentioned above with less than 1 bubble/kg is achieved for special glass at a melting load of more than 1 t/m²d.

The object is achieved by a method for melting and refining glass, glass ceramic, or in particular glass that is ceramizable to form glass ceramic, which includes less than 1 bubble/kg in the molten and refined glass or in the molten and refined glass ceramic after the melting and refining, in which direct CO₂ emissions, especially from fossil fuels, amount to less than 100 kg/t of molten glass during the melting and refining.

The object is also achieved by an apparatus for melting and refining glass, glass ceramic, or in particular glass that is ceramizable to form glass ceramic, in particular a melting system for carrying out the method according to the invention, with less than 1 bubble/kg included in the molten and refined glass or in of the molten and refined glass ceramic after the melting and refining, and in which direct CO₂ emissions, in particular from fossil fuels, amount to less than 100 kg/t of molten glass during the melting and refining.

In the context of the present disclosure, the term “energy source” shall include any forms of a source of energy, i.e. in particular electrical energy, synthetic fuels, and fossil fuels.

Advantageously, an all-electric tank is used as a device for melting glass or glass ceramic, i.e. as a melting tank, and high-temperature refining is performed in particular inside cold walls, and the electrical energy for this is provided by electricity that has an at least neutral CO₂ balance.

In the context of the present disclosure, the generation of electricity is regarded as having a neutral CO₂ balance if the amount of CO₂ present overall is not increased by the generation of the electricity.

Consequently, electricity generated by solar energy, wind, hydro, and/or nuclear power is considered to have a neutral carbon footprint, i.e. a neutral CO₂ balance.

Fuels obtained through biological processes, which are generically also referred to as biofuels, or substances obtained through chemical reactions, which are obtained with the help of solar energy, for example, such as in methanol production the methanol that is also referred to as methanol solar fuel, are considered to have a neutral CO₂ balance if they do not lead to an overall increase in the CO₂ content of the atmosphere during their production and subsequent use.

Thus, biofuels can include synthetically produced methane, H₂, bioethanol, and biologically produced oils.

Subsequent use thereof refers to all forms of use of these fuels obtained by biological processes or substances obtained by chemical reactions, which are obtained using solar energy or an energy supply that does not release any CO₂, as described in the present disclosure.

Thus, these aforementioned fuels or substances are not included in the specified direct emissions of CO₂, in particular from fossil fuels, which amount to less than 100 kg per ton of molten glass during the melting and refining, since these fuels or substances as a whole will not release any further CO₂ during the presently disclosed method.

In the context of the present disclosure, cold walls are understood to mean peripheral glass sections which have a sufficiently low temperature so that the glass is solidified and in particular has a temperature below the T_{g} of the respective molten and refined glass. Such walls define a crucible for the molten glass and are also referred to as skull crucibles, as is known to those skilled in the art.

For the sake of completeness, it should be noted that the presently disclosed invention is in particular not limited to the fact that redox refining agents must or can be used.

The subject-matter of the presently disclosed invention is also suitable for use in conjunction with refining in which a chloride refining agent is employed.

Optionally, an SnO₂ refining agent can be used, in particular in amounts between 0.05 and 0.8 wt %. Furthermore, a colorant can optionally be provided, in particular MoO₃. Additionally or alternatively, Fe₂O₃, V₂O₅, CeO₂, and/or TiO₂ can be employed as well.

It has been found that the coloring with molybdenum oxide is also based on a redox process. In the crystallizable starting glass, the color imparting effect by MoO₃ is still relatively weak. It is assumed that the redox process occurs during ceramization, the molybdenum is reduced, and the redox partner, e.g. Sn²⁺ is oxidized to give Sn⁴⁺. Investigations have shown that the coloring with molybdenum requires a stronger redox reaction than the coloring with vanadium. Therefore, the stronger reducing refining agent SnO₂ is preferred in amounts from 0.05 to 0.8 wt %. Lower contents are not very effective for the refining, higher contents favor undesired devitrification during shaping due to Sn-containing crystals. Preferably, the SnO₂ content is from 0.1 to <0.7 wt %. Most preferably, the SnO₂ content is less than 0.6 wt %. Coloring with other refining agents as redox partners, such as antimony or arsenic oxide, turned out to be less effective.

Since the coloring by molybdenum oxide is a redox process, the redox state that is set in the glass during the melting, for example due to high melting temperatures and long dwell times at high temperatures or the addition of reducing constituents, has an influence as well. Furthermore, the ceramization conditions have an influence on the coloring effect. In particular high ceramization temperatures and extended ceramization durations will cause stronger coloring. Additions of other polyvalent components such as Fe₂O₃, V₂O₅, CeO₂, TiO₂ can influence the redox process in addition to their own coloring effect, and can thus have an impact on the molybdenum oxide coloring with regard to brightness and color coordinates of the glass ceramic.

Very advantageously, the melting is followed by a step of increasing the temperature, which promotes the elimination of bubbles. Chloride or sulphate refining can be employed additionally or in particular for promoting this purpose.

Advantageously, radio frequency refining, also referred to as RF refining, is performed.

Alternatively or additionally, a skull crucible and high-load electrodes can be used for the refining.

In particular embodiments, temperatures from 1700° C. to 2400° C. are reached during the high-temperature refining, at least in some zones of the glass to be refined or the glass ceramic to be refined, and in the case of glass ceramics, i.e. for glasses that are to be further processed into glass ceramics, temperatures from 1700° C. to 2000° C. are preferably reached.

In further embodiments, the refining unit is additionally heated, in particular additionally heated using an energy source that comprises electrical energy.

For example, radiant electric heating can be employed for the additional heating.

In yet further embodiments, the refining unit can be additionally heated in particular using an energy source that is free of electrical energy.

For this purpose, H₂ burners can be used for the additional heating, and/or a burner for synthetically obtained or fossil methane (CH₄), plasma flames, biogas and/or biofuel burners.

Preferably, the auxiliaries used for the additional heating or the energy sources used for this purpose are produced or provided without fossil energy sources.

The method presently disclosed allows to achieve throughputs of more than 10 t/d for special glass.

Usually, throughputs of less than 200 t/d are achieved with the method presently disclosed.

Advantageously, a presently disclosed apparatus comprises an all-electric tank as a melting tank, which is solely supplied with electrical energy for heating the material contained therein and which is referred to as an AE tank, and a device for high-temperature refining, in particular a device which has cold walls during the refining, and the electrical energy is preferably provided by electricity that has at least a neutral CO₂balance.

A device for radio frequency refining, also referred to as RF refining, has found to be particularly advantageous for the purposes of the present invention. Document DE 102 36 136 A1 of the present Applicant discloses an appropriate radio frequency-heated cold crucible that can be used for this purpose, which is in particular intended for melting inorganic material. The disclosure of this document is incorporated into the subject-matter of the present application by reference.

As an alternative or in addition, a skull crucible can also be used as a device for high-temperature refining, i.e. in particular a refining crucible with cold walls and high-load electrodes.

The device for high-temperature refining may also comprise auxiliary heating means.

For example, the auxiliary heating means can be selected from the group consisting of an H₂ burner, a burner for synthetically obtained or fossil methane (CH₄), plasma flames, biogas and/or biofuel burner.

The device presently disclosed is designed for a throughput of more than 10 t/d of special glass.

This minimum throughput allows for efficient manufacture of special glass products in continuous processes.

The presently disclosed apparatus is designed for a throughput of less than 200 t/d of special glass.

Referring to specifications on CO₂ emissions and/or CO₂ equivalents, such as the fact that direct CO₂ emissions in particular from fossil fuels amount to less than 100 kg/t of molten glass during the melting and refining, it is in particular contemplated within the context of the present application to exclude the amount of CO₂ from the melting reaction of the raw materials.

The following equivalents can in particular be used:

240 g/kWh CO₂ with natural gas H

310 g/kWh CO₂ with extra-light heating oil

567 g/kWh CO₂ with electricity (energy mix DE 2016)

Accordingly, for 1 kWh heat from natural gas H, a CO₂ equivalent of 240 g/kWh CO₂ is resulting, 310 g/kWh CO₂ for 1 kWh heat from extra-light heating oil, and 567 g/kWh CO₂ for 1 kWh heat from electricity.

For example, if a melting tank with a daily output of 40 tons of glass is heated with an amount of 500 cbm/h of natural gas, and if only the CO₂ equivalent from the combustion of fossil energy is taken into account, and with a conversion factor according to which 1 cbm of natural gas corresponds to 10 kWh of heat, this results in a CO₂ equivalent of 28.8 tons released for this melting process per day. Thus, a CO₂ equivalent of approx. 720 kg/t of glass is resulting per ton of glass.

With regard to the greenhouse gas emissions of the various energy sources, reference is made to Pehnt et al., Investigation into primary energy factors, Final report, Work in accordance with the framework agreement for advising Department II of the BMWi, Heidelberg, Berlin, Apr. 23, 2018, online at: https://www.gih.de/wp-content/uploads/2019/05/Untersuchung-zu-Prim%C3%A4renergiefaktor.pdf, esp. page 29.

In the case of oxygen as an aid for combustion, a CO₂ equivalent of in particular 0.45 kWh of electricity per cbm of O₂ can be used, corresponding to the energy required to produce oxygen.

Furthermore in the context of the present application, data on CO₂ emissions and/or CO₂ equivalents in units of kg/t of glass are to be understood in particular as data relating to melted glass.

The invention also encompasses a glass or a glass ceramic producible or produced by a method as presently disclosed and preferably in a device as presently disclosed.

Glasses that are used as the glasses described within the context of the present disclosure for carrying out the method presently disclosed, preferably in the apparatus that is likewise disclosed here, include in particular aluminosilicate glasses and glass ceramics, aluminoborosilicate glasses, and borosilicate glasses, in correspondence with the above definition for special glasses.

### BRIEF DESCRIPTION OF THE DRAWINGS

The invention will now be described in more detail by way of several embodiments and with reference to the accompanying drawings, wherein:

FIG. 1 is a top plan view of a first exemplary embodiment (MT1), with the top or covers omitted for the sake of better comprehension, the melting tank having a throughput of more than 10 up to 200 t/d, and comprising an AE tank and a radio frequency refining tank (RF RT);

FIG. 2 is a cross-sectional view of the first exemplary embodiment (MT1), with the sectional plane cutting vertically approximately through the middle of the melting system, the melting tank having a throughput of more than 10 up to 200 t/d, and comprising an AE tank and a radio frequency refining tank (RF RT);

FIG. 3 is a top plan view of a second exemplary embodiment (MT2), with the top or covers omitted for the sake of better comprehension, the melting tank having a throughput of more than 10 up to 200 t/d, and comprising an AE tank and a refining tank with a skull crucible and high-load electrodes;

FIG. 4 is a cross-sectional view of the second exemplary embodiment (MT2), with the sectional plane cutting vertically approximately through the middle of the melting system, the melting tank having a throughput of more than 10 up to 200 t/d, and comprising an AE tank and a refining tank which includes a skull crucible and high-load electrodes;

FIG. 5 is a top plan view of a third exemplary embodiment (MT3), with the top or covers omitted for the sake of better comprehension, the melting tank having a throughput of more than 10 up to 200 t/d, and comprising an AE tank and a platinum refining tank;

FIG. 6 is a cross-sectional view of the third exemplary embodiment (MT3), with the sectional plane cutting vertically approximately through the middle of the melting system, the melting tank having a throughput of more than 10 up to 200 t/d, and comprising an AE tank and a platinum refining tank;

FIG. 7 is a top plan view of a fourth exemplary embodiment (MT4), with the top or covers omitted for the sake of better comprehension, the melting tank having a throughput of more than 10 up to 200 t/d, and comprising an AE tank and a vacuum refining tank;

FIG. 8 is a cross-sectional view of the fourth exemplary embodiment (MT4), with the sectional plane cutting vertically approximately through the middle of the melting system, the melting tank having a throughput of more than 10 up to 200 t/d, and comprising an AE tank and a vacuum refining tank;

FIG. 9 is a top plan view of a fifth exemplary embodiment (MT5), with the top or covers omitted for the sake of better comprehension, the melting tank having a throughput of more than 10 up to 200 t/d, and comprising an AE tank and a boost EAH refining tank;

FIG. 10 is a cross-sectional view of the fifth exemplary embodiment (MT5), with the sectional plane cutting vertically approximately through the middle of the melting system, the melting tank having a throughput of more than 10 up to 200 t/d, and comprising an AE tank and a boost EAH refining tank;

FIG. 11 is a top plan view of a sixth exemplary embodiment (MT6), with the top or covers omitted for the sake of better comprehension, the melting tank having a throughput of more than 10 up to 200 t/d, and comprising an AE tank and a high electric current refining tank; and

FIG. 12 is a cross-sectional view of the sixth exemplary embodiment (MT6), with the sectional plane cutting vertically approximately through the middle of the melting system, the melting tank having a throughput of more than 10 up to 200 t/d, and comprising an AE tank and a high electric current refining tank.

### DETAILED DESCRIPTION

In the following description of the preferred embodiments, the same reference numerals denote the same or equivalent components or assemblies in the respective discussed embodiments. For the sake of clarity and better comprehension only, the figures are not drawn to scale.

In the context of the present disclosure, as already stated in the introductory part, direct CO₂ emissions refer to those CO₂ emissions that arise in the vicinity of the tank itself, i.e. which are caused by the heating of the tank with the glass to be melted contained therein or with of the glass ceramic contained therein, and by the refining. In the context of the present disclosure, glass ceramic also refers to glasses which do not yet have any crystalline fractions, but which can later be transformed into glass ceramics by appropriate time-dependent heat application.

In the present context, the term of glass ceramic shall in particular also encompass glass ceramic material in the batch, which is melted and refined by the presently disclosed method and which can be added to the batch for recycling purposes, for example, and can form part thereof.

However, the term glass ceramic is also intended to disclose the respective glasses that can be converted into glass ceramic, in particular ceramizable and/or crystallizable glasses, and is thus intended to express that it comes within the scope of the present disclosure for these glasses that can be further processed into glass ceramics, after the refining, to perform a respective ceramization or to cause crystallization processes, as is known to persons skilled in the art.

Such corresponding ceramization processes which are known to those skilled in the art, or the causing of corresponding crystallization processes also form part of the presently disclosed method for glasses which can be converted into glass ceramics.

Typical glass ceramics include the glass ceramics marketed by Schott AG under the trade names Ceran® and Robax®, for example.

The glasses presently disclosed for producing glass articles include the groups of borosilicate (BS), aluminosilicate (AS), and boroaluminosilicate glasses, and lithium aluminum silicate glass ceramics (LAS), which are mentioned here by way of example, without losing the claim of generality.

In particular a glass with an Li₂O content from 4.6 wt % to 5.4 wt % and an Na₂O content from 8.1 wt % to 9.7 wt % and an Al₂O₃ content from 16 wt % to 20 wt % can be used as an Li—Al—Si glass.

For example, a Li—Al—Si glass with a composition comprising 3.0-4.2 of Li₂O, 19-23% of Al₂O₃, 60-69 wt % of SiO₂, as well as TiO₂ and ZrO₂ can be used as a glass that is ceramizable to form a glass ceramic, also known as a green glass.

Furthermore, a glass or a glass that is ceramizable to form a glass ceramic with an Li₂O content of less than 3 wt % can also be used.

A glass containing the following components (in wt %) can be used as a borosilicate glass:

| | |
|---|---|
| SiO₂ | 70-87 |
| B₂O₃ | 7-25 |
| Na₂O + K₂O | 0.5-9 |
| Al₂O₃ | 0-7 |
| CaO | 0-3. |

A glass in particular with the following composition can also be used as a borosilicate glass:

| | | |
|---|---|---|
| SiO₂ | 70-86 | wt % |
| Al₂O₃ | 0-5 | wt % |
| B₂O₃ | 9.0-25 | wt % |
| Na₂O | 0.5-5.0 | wt % |
| K₂O | 0-1.0 | wt % |
| Li₂O | 0-1.0 | wt %; |

or else a glass, in particular an alkali borosilicate glass, which contains:

| | | |
|---|---|---|
| SiO₂ | 78.3-81.0 | wt % |
| B₂O₃ | 9.0-13.0 | wt % |
| Al₂O₃ | 3.5-5.3 | wt % |
| Na₂O | 3.5-6.5 | wt % |
| K₂O | 0.3-2.0 | wt % |
| CaO | 0.0-2.0 | wt %. |

A pharmaceutical glass can also be used, for example a glass marketed by Schott AG under the trade name Fiolax® (e.g. Fiolax® Pro, Fiolax® clear).

In one example, a glass such as a borosilicate glass can be used, which contains:

| | | |
|---|---|---|
| SiO₂ | 71-77 | wt % |
| B₂O₃ | 9-12 | wt % |
| Al₂O₃ | 4.5-8 | wt % |
| Na₂O | 6-8 | wt % |
| K₂O | 0-3 | wt % |
| CaO | 0-2 | wt % |
| BaO | 0-1.5 | wt %. |

Emissions of CO₂ as generated by the provision of electrical energy are not referred to as direct CO₂ emissions in the context of the present disclosure, however, as already mentioned above, it is advantageous to accordingly reduce such emissions as well, in particular to at least ensure a neutral CO₂ balance.

Each of the accompanying figures illustrates a device 1 for melting and a device 2 for refining glass and/or glass ceramic, which together are in particular also referred to as a melting system.

The melting device 1 is an all-electric tank, i.e. a tank that is fully and solely heated using electrical energy. This tank is also referred to as an AE tank or all-electric meltdown tank, the latter term usually being employed to express that a batch is melted and not a previously molten and resolidified glass.

Current-carrying rod electrodes 3 protrude into the melt 3a which is covered by a batch 6 that is fed onto and resupplied to the melt 3a by feeding machines to produce a batch cover that is caused to melt down inside the device.

The refining device 2 comprises a radio frequency, in particular inductively heated refining tank, also referred to as an RF refining tank, or a tank heated by high-load electrodes 12 which cause electric current to flow through the material to be refined.

The devices 1 and 2 are made of or are lined with refractory material 5 in their wall areas, in particular the wall areas in contact with the melt 3a.

These devices 1 and 2 of the presently disclosed embodiments permit to implement a method in which the molten and refined glass 3a, 3b or the molten and refined glass ceramic 3a, 3b includes less than 1 bubble/kg after the melting and refining, and in which direct CO₂ emissions especially from fossil fuels amount to less than 100 kg per ton of molten glass 3a, 3b during the melting and refining.

Here, the specification of the number of bubbles/kg after the melting and refining also correspond to the number of bubbles/kg in a later, optionally additionally hot-formed product, for example also in a hot-formed glass ceramic product.

Device 2 is a device for high-temperature refining, in particular a device which has cold walls during the refining, i.e. which forms a respective skull crucible 11 that is distinguished by its cold walls consisting of the melted and resolidified glass 3a.

As a result, very efficient refining can be performed, in particular due to the respective very high temperatures reaching temperatures between 1700° C. and 2400° C. in the method presently disclosed, at least in some zones of the glass to be refined or the glass ceramic to be refined, and for glass ceramics, i.e. for glasses to be further processed into glass ceramics, temperatures from 1700° C. to 2000° C. should preferably be achieved.

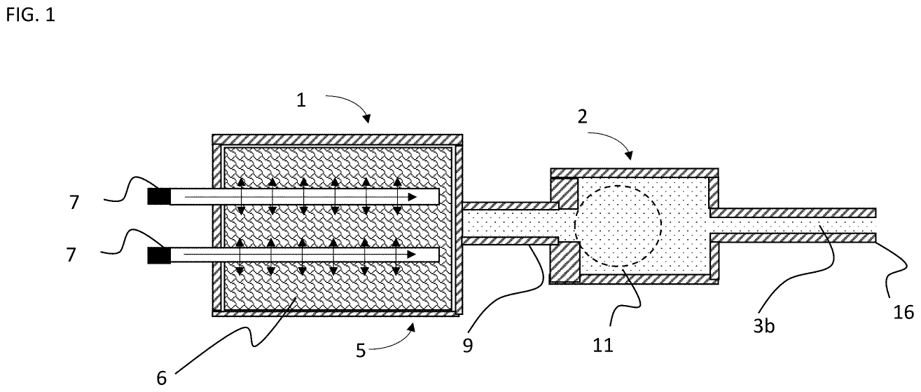

By way of example, FIG. 1 shows a top plan view of a first embodiment, with the top or covers omitted for the sake of better comprehension, in which the melting tank of the device 1 for melting glass or glass ceramic is an AE melting tank and has a throughput of more than 10 up to 200 t/d, and in which the device 2 for refining glass or glass ceramic comprises a radio frequency refining tank, RF RT.

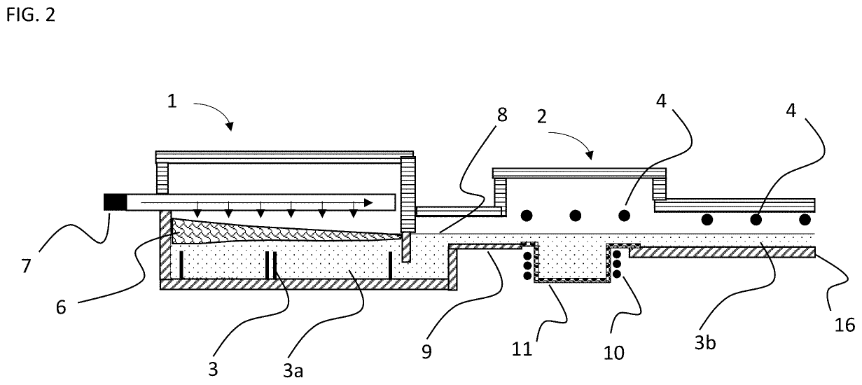

FIG. 2 shows a cross-sectional view of this first exemplary embodiment, with the sectional plane cutting vertically approximately through the middle of the melting system, i.e. through the middle of the device 1 for melting glass or glass ceramic and of the device 2 for refining glass or glass ceramic.

The device 1 for melting glass or glass ceramic comprises rod electrodes 3 arranged therein for heating the melt, while the device 2 for refining glass or glass ceramic comprises one or more induction coils 10 which provide radio frequency heating for the glass inside the skull crucible 11, and moreover comprises auxiliary heating means in the form of gas burners 4.

This auxiliary heating with gas burners 4 may involve any of one or more H₂ burners, burners for synthetically obtained or produced methane (CH₄), plasma flames, biogas and/or biofuel burners.

The molten glass 3a exiting the device 1 following the melting preferably enters the device 2 for being refined through a distributor 9 and leaves it for further use through channel 16, for example in order to be fed to a downstream hot forming process.

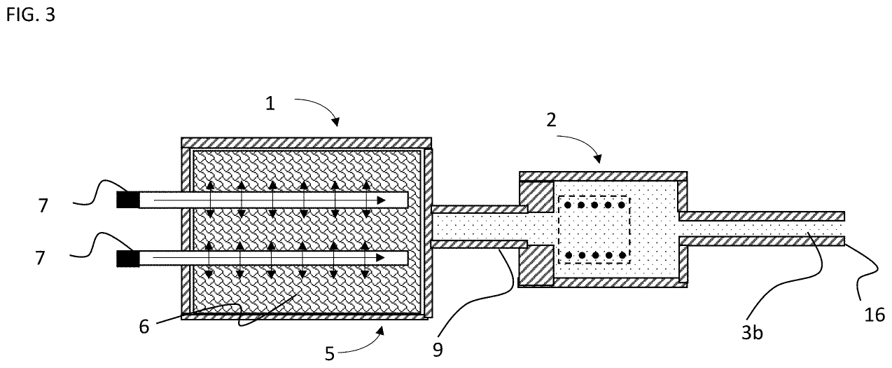

FIG. 3 shows a top plan view of a second exemplary embodiment, with the top or covers omitted for the sake of better comprehension, in which the melting tank of the device 1 for melting glass or glass ceramic has a throughput of more than 10 up to 200 t/d and comprises an AE melting tank which is also heated by rod electrodes 3 through which electric current is passed, and in which the device 2 for refining glass or glass ceramic comprises a refining tank with a skull crucible 11 and high-load electrodes 12 for heating the latter.

Again in this exemplary embodiment, burners 4 are provided for additional heating. For the sake of clarity, the burners 4 are each represented by round black circles in the figures, however without each being denoted by an own reference numeral.

As with the first exemplary embodiment, the glass surface 8 of the molten glass 3a or of the molten glass ceramic 3a and the glass surface 8 of the molten and refined glass 3b or of the molten and refined glass ceramic 3b is only slightly inclined in the flow direction.

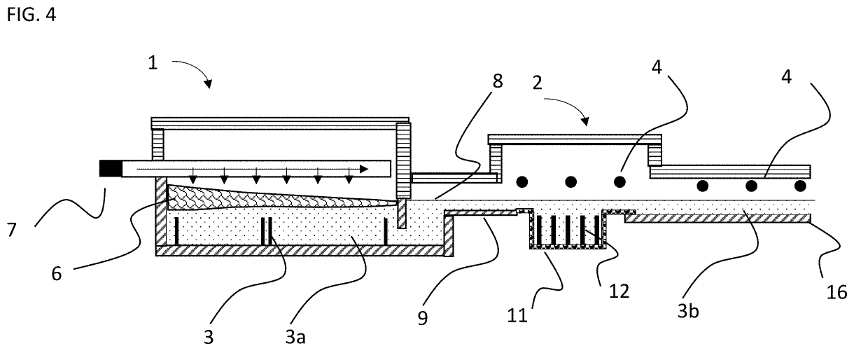

FIG. 4 shows a cross-sectional view of the second exemplary embodiment, with the sectional plane cutting vertically approximately through the middle of the melting system.

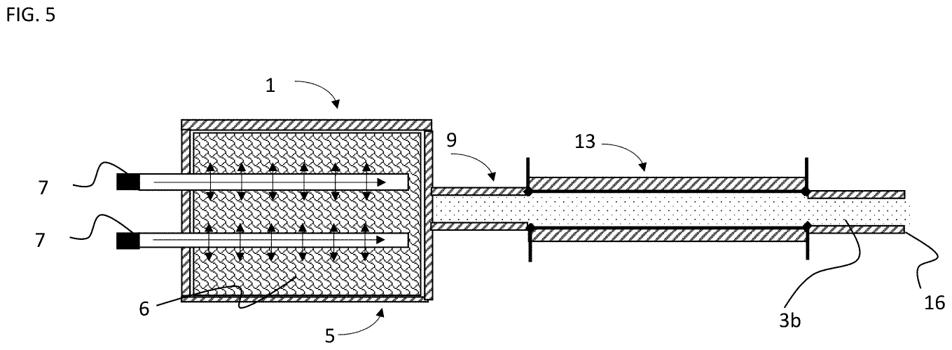

FIG. 5 shows a top plan view of a third embodiment, with the top or covers omitted for the sake of better comprehension, in which the melting tank has a throughput of more than 10 up to 200 t/d and comprises an AE melting tank and a platinum refining tank with a platinum refining tube 13.

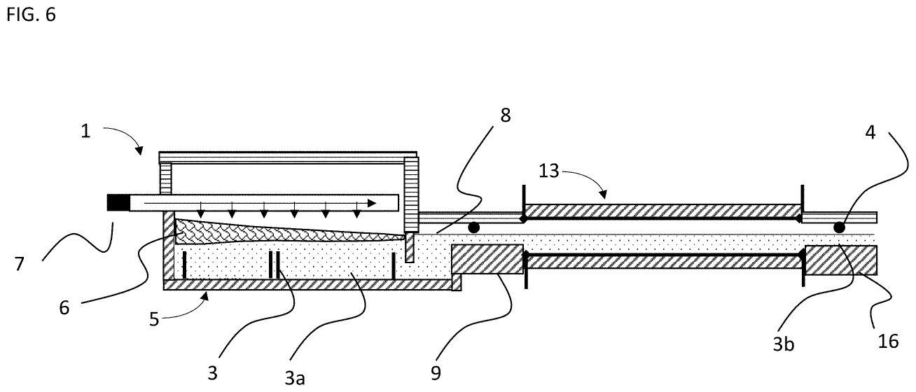

FIG. 6 shows a cross-sectional view of this third exemplary embodiment, with the sectional plane cutting vertically approximately through the middle of the melting system.

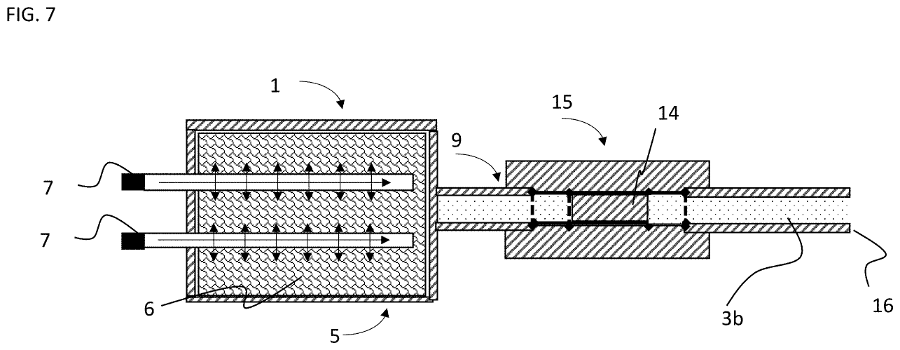

FIG. 7 discloses a top plan view of a fourth embodiment, with the top or covers omitted for the sake of better comprehension, in which the melting tank of the device 1 for melting glass or glass ceramic has a throughput of more than 10 up to 200 t/d and comprises an all-electric AE tank, for example, and in which the device 2 for refining glass or glass ceramic comprises a vacuum refining tank which includes a vacuum refining channel 15 made of platinum, which defines a negative pressure zone 14.

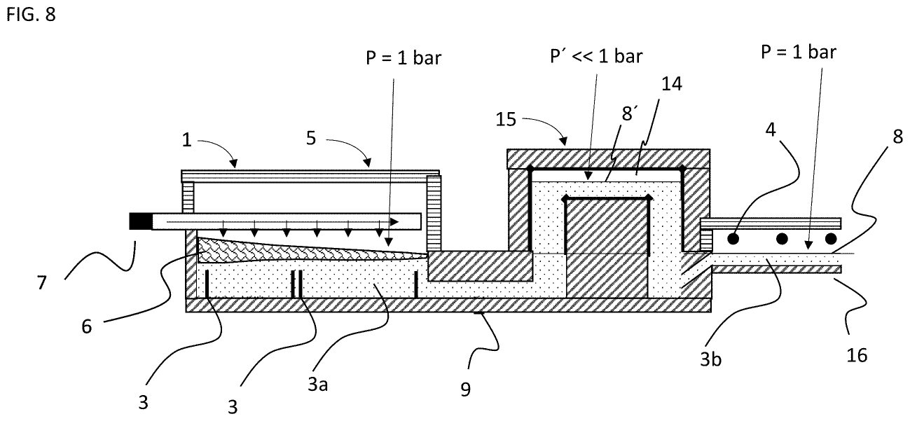

FIG. 8 shows a cross-sectional view of this fourth exemplary embodiment, which also indicates the respective locally prevailing pressure conditions.

In device 1, in channel or distributor 9, and in channel 16, a pressure P is adjusted which approximately corresponds to atmospheric pressure of about 1 bar. Due to the pressure P′ prevailing in negative pressure zone 14, which is much lower than atmospheric pressure, the molten glass 3a is raised during the refining, as can be clearly seen from the higher level of glass bath surface 8′, which allows for very efficient and energy-saving refining.

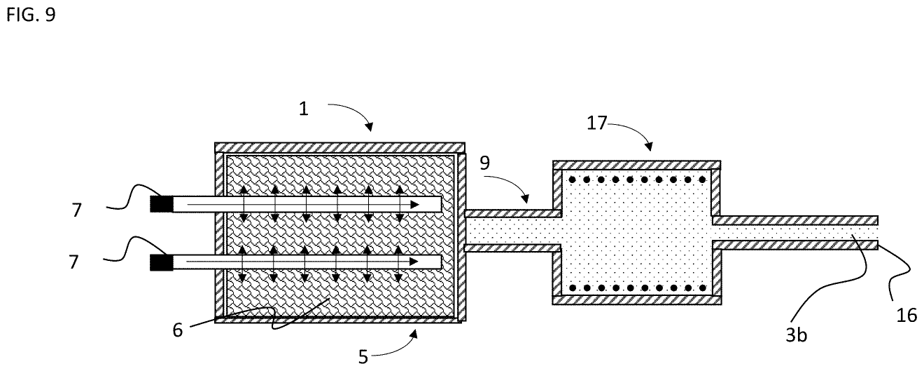

FIG. 9 shows a top plan view of a fifth exemplary embodiment, with the top or covers omitted for the sake of better comprehension, in which the melting tank has a throughput of more than 10 up to 200 t/d, and in which the device 1 comprises an AE tank and the device 2 comprises a boost EAH refining tank 17. The boost EAH refining tank 17A comprises a refining tank with electrical auxiliary heating such as disclosed in present Applicant's DE 10 304 973 A1, for example. The disclosure of this document is incorporated into the subject-matter of the present application by reference. Auxiliary heating is implemented by rod electrodes 3 in refining device 2 and is capable of providing more than 90% of the energy input required for heating. Nevertheless, the burners 4 described above can also be used in addition thereto.

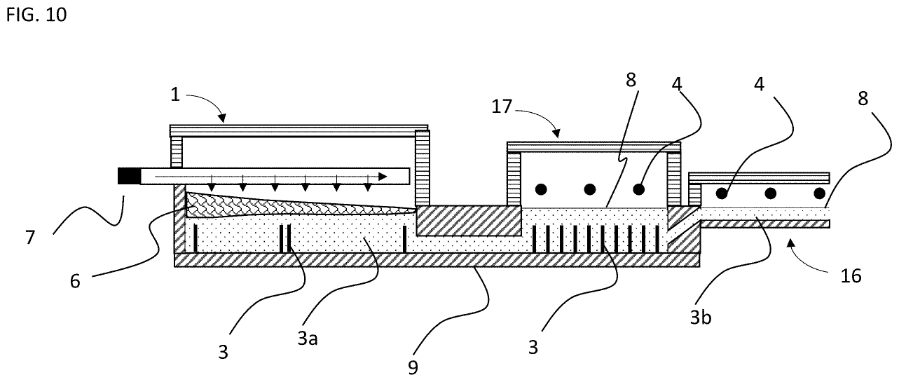

FIG. 10 shows a cross-sectional view of this fifth exemplary embodiment, with the sectional plane cutting vertically approximately through the middle of device 1 and of device 2.

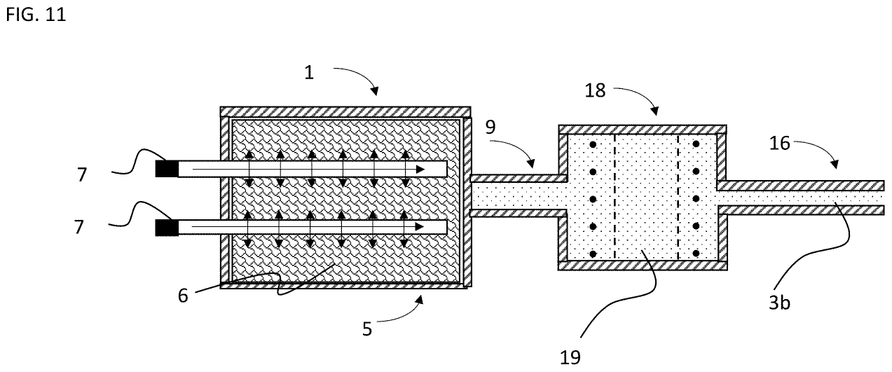

FIG. 11 discloses a top plan view of a sixth embodiment, with the top or covers omitted for the sake of better comprehension, in which the melting tank has a throughput of more than 10 up to 200 t/d, and in which device 1 comprises an AE tank and device 2 comprises a high electric current refining tank 18. Again, in this high electric current refining tank 18, electrical auxiliary heating can be employed using rod electrodes 3 which are capable of providing more than 90% of the electrical energy required for heating. Nevertheless, the burners 4 as described above can also be used in addition thereto.

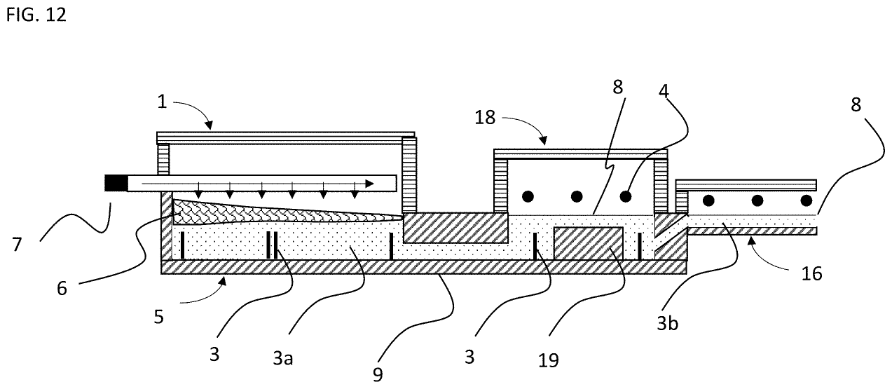

The cross-sectional view of FIG. 12 of the sixth exemplary embodiment, with the sectional plane cutting vertically approximately through the middle of the melting system, shows a barrier 19 for narrowing the cross section of the flow of molten glass 3a, 3b, which barrier is effective to increase the current density flowing between the rod electrodes 3 preferably in the flow direction of the molten glass 3a, 3b, since the barrier 19 is made of non-conductive refractory material. This increase in electrical resistance in the area above the barrier 19 greatly increases the temperature of the molten glass 3a, 3b, which results in the refining becoming much more efficient in this area. The reduction in the height of the molten glass that is present above the barrier 19 also results in an acceleration of the release of bubbles during this refining.

The table below shows conventional embodiments of melting tanks MT and refining tanks RT, in which fossil fuels such as gas and oil are used in the burners.

| | | | CO₂ from | | Typical |
|---|---|---|---|---|---|
| | | CO₂ from | fossil | Total CO₂ | glass |
| Type of | Type of | batch | energy | (fossil) | quality |
| glass | tank | kg/t glass | kg/t glass | kg/t glass | bubbles/kg |
| BS | tank B | 0 | 530 | 530 | <0.5 |
| BS | tank A | 0 | 440 | 440 | <0.5 |
| AS | tank B | 30 | 625 | 625 | <1.0 |
| LAS | tank B | 90 | 565 | 565 | <1.0 |
| LAS | tank C | 5 | 330 | 330 | <0.2 |
| LAS | tank D | 5 | 303 | 305 | <0.2 |
| LAS | tank E | 30 | 550 | 550 | <0.2 |
| BS | tank F | 20 | 187 | 187 | <1.0 |
| BS | tank G | 20 | 610 | 610 | <1.0 |
| BS | tank H | 20 | 1130 | 1130 | <1.0 |

Exemplary implementations of the embodiments as disclosed above, in particular with regard to the method according to the invention and the apparatus according to the invention with respect to CO₂ emissions from fossil fuels, in particular from melting tanks MT and refining tanks RT for the production of special glass, are listed in the table below.

| | | | CO₂ | | CO₂ | | | |
|---|---|---|---|---|---|---|---|---|
| | | | from | | from | | | |
| | | CO₂ | fossil | Glass | fossil | CO₂ | Glass | Total |
| | | from | energy | quality | energy | from | quality | CO₂ |
| Type | Type | batch | MT | downstream | RT | H₂ or | downstream | fossil |
| of | of | kg/t | kg/t | MT | kg/t | biofuel | RT | kg/t |
| glass | tank | glass | glass | bubbles/kg | glass | RT | bubbles/kg | glass |
| LAS | MT1 | 5 | 0 | <1000 | 50 | | <0.2 | 50 |
| LAS | MT1 | 5 | 0 | <1000 | 0 | X | <0.2 | 0 |
| LAS | MT1 | 30 | 0 | <1000 | 70 | | <0.2 | 70 |
| LAS | MT1 | 30 | 0 | <1000 | 0 | X | <0.2 | 0 |
| LAS | MT1 | 90 | 0 | <1000 | 70 | | <0.2 | 70 |
| LAS | MT1 | 90 | 0 | <1000 | 0 | X | <1.0 | 0 |
| AS | MT2 | 30 | 0 | <100 | 50 | | <1.0 | 50 |
| AS | MT2 | 30 | 0 | <100 | 0 | X | <1.0 | 0 |
| AS | MT3 | 30 | 0 | <100 | 10 | | <1.0 | 10 |
| AS | MT3 | 30 | 0 | <100 | 0 | X | <1.0 | 0 |
| BS | MT5 | 0 | 0 | <100 | 90 | | <0.5 | 90 |
| BS | MT5 | 0 | 0 | <100 | 0 | X | <0.5 | 0 |
| BS | MT6 | 20 | 0 | <500 | 90 | | <1.0 | 90 |
| BS | MT6 | 20 | 0 | <500 | 0 | X | <1.0 | 0 |
| BS | MT2 | 20 | 0 | <500 | 50 | | <1.0 | 50 |
| BS | MT2 | 20 | 0 | <500 | 0 | X | <1.0 | 0 |

However, in all the examples in the table above regarding glass quality downstream of refining tank RT, in particular downstream of the refining tank RT according to the invention, even half the specified number of bubbles/kg is preferably achieved with the presently disclosed embodiments, and most preferably even a quarter of the specified number of bubbles/kg.

Generally, the tank types described above are designed for a throughput of less than 200 tons per day for special glass.

### LIST OF REFERENCE NUMERALS

1 Device for melting glass, glass ceramic or in particular glass ceramizable to form glass ceramics, e.g. AE meltdown tank or AE melting tank (MT),

2 Device for refining glass or glass ceramic, e.g. all-electric radio frequency or RF refining tank (RT),

3 Rod electrodes

3a Melt of the molten glass or molten glass ceramic

3b Melt of the molten and refined glass or the molten and refined glass ceramic

4 Gas burners (synthetic or fossil CH₄, H₂, or biofuel in combustion with oxygen)

5 Refractory material

6 Batch, providing a batch cover and subsequently leading to meltdown

7 Feeding machines

8 Glass bath surface

8′ Glass bath surface at a higher level as caused by negative pressure P′

9 Distributor

10 RF induction coil

11 Skull crucible

12 High-load electrodes

13 Pt refining tube

14 Negative pressure zone of vacuum refining channel 15, preferably having walls made of platinum

15 Vacuum refining channel (Pt)

16 Channel

17 Boost EAH refining tank with more than 90% of electrical auxiliary heating (EAH)

18 High electric current refining tank with more than 90% of electrical auxiliary heating (EAH)

19 Barrier for narrowing the flow cross section

What is claimed is:

1. A method for melting and refining glass, glass ceramic, glass ceramizable to form glass ceramic, comprising:
controlling a melting and refining process so that molten and refined glass is provided that has less than 1 bubble/kg; and
controlling the melting and refining process so that direct CO₂ emissions during the melting and refining process amount to less than 100 kg per ton of the molten and refined glass.

2. The method of claim 1, wherein the melting and refining process comprises melting and refining in an all-electric tank using electrical energy that has at least a neutral CO₂balance.

3. The method of claim 1, wherein the melting and refining process comprises radio frequency refining.

4. The method of claim 1, wherein the melting and refining process comprises using a skull crucible and high-load electrodes.

5. The method of claim 1, wherein the melting and refining process comprises heating to a temperature from 1700° C. to 2400° C. least in some zones of the molten and refined glass.

6. The method of claim 1, wherein the melting and refining process comprises heating to a temperature from 1700° C. to 2000° C. least in some zones of the molten and refined glass.

7. The method of claim 1, wherein the melting and refining process further comprises additionally heating the molten and refined glass using an additional heating unit.

8. The method of claim 7, wherein the additional heating unit comprises electric radiant heating.

9. The method of claim 7, wherein the additional heating unit heats using an energy source that is free of electrical energy.

10. The method of claim 9, wherein the additional heating unit comprises a burner burning a fuel selected from a group consisting of H₂, synthetic methane, fossil methane, biogas, biofuel, and combinations thereof.

11. The method of claim 10, wherein the additional heating unit generates plasma flames.

12. The method of claim 1, wherein the melting and refining process has a throughput of the molten and refined glass of more than 10 tons per day.

13. The method of claim 1, wherein the melting and refining process has a throughput of the molten and refined glass of more than 200 tons per day.

14. The method of claim 1, further comprising ceramicizing the molten and refined glass.

15. An apparatus for melting and refining glass, glass ceramic, or glass that is ceramizable to form glass ceramic, comprising:
a melting and refining system controllable to produce molten and refined glass with less than 1 bubble/kg, wherein the melting and refining system produces direct CO₂ emissions of less than 100 kg per ton of the molten and refined glass.

16. The apparatus of claim 15, wherein the melting and refining system comprises an all-electric tank and a high-temperature refining device, wherein the melting and refining system has cold walls during the refining, and wherein the melting and refining system is configured to use electrical energy that has at least a neutral CO₂balance.

17. The apparatus of claim 16, wherein the melting and refining system comprises an RF refining device.

18. The apparatus of claim 16, wherein the high-temperature refining includes device further comprises an auxiliary heating device with a burner that burns a fuel selected from a group consisting of H₂, synthetic methane, fossil methane, biogas, biofuel, and combinations thereof.

19. The apparatus of claim 15, wherein the melting and refining system comprises a skull crucible with high-load electrodes.

20. A glass or glass ceramic, comprising:
a panel having less than 1 bubble/kg, the panel being configured for a use selected from a group consisting of cookware, fireplace window glass, a cooking surface, a grilling surface, a frying surface, fire protection glazing, oven window glass, a pyrolysis oven window glass, a lighting cover, safety glass, a laminated composite safety glass, a support panel, an oven lining,
wherein the panel has a property selected from a group consisting of a thickness between 2.5 mm and 6 mm, a light transmittance between 5% and 80%, and a dimple pattern provided on at least one surface at least in sections thereof.
